(19) United States
(12) Patent Application Publication
(10) Pub. No.: US 2008/0172309 A1
(43) Pub. Date: Jul. 17, 2008

(54) Online marketing

(76) Inventor: John Reimer, San Jose, CA (US)

Correspondence Address: DAVID LEWIS, 1250 AVIATION AVE., SUITE 200B, SAN JOSE, CA, 95110, US

(21) Appl. No.: 12/009,050

(22) Filed: Jan. 16, 2008

Related U.S. Application Data
(60) Provisional application No. 60/880,782, filed on Jan. 16, 2007.

(51) Int. Cl. G06F 17/00; G06F 17/30; G06Q 30/00

(52) U.S. Cl. 705/27; 707/3; 707/100; 705/500; 705/26; 707/E17.014

(57) ABSTRACT

In an embodiment an item is offered for download at an initial offering, which may be free. In an embodiment, reviews of the item are sought. After receiving a predetermined number of orders for the item, increasing the price of the item. In an embodiment, the buyers establish accounts in a virtual bank and purchase the items with funds in the buyer's account in the virtual bank. In an embodiment items are presented to a potential buyer in an order dependent on the number of downloads of the items. Any of the above embodiments may be used alone or together with one another in any combination.

### CROSS-REFERENCE TO RELATED APPLICATIONS

This application claims priority benefit of U.S. Provisional Patent Application No. 60/880,782, filed Jan. 16, 2007, which is incorporated herein by reference.

### FIELD

This invention relates in general to websites for selling items.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Websites exist that are used for selling a variety of types of merchandise. However, if someone wants to sell an item that is expected to have a relatively small value it may be difficult. For example, if an unknown author has a single joke, a single recipe, or even a book, the author may never share their contribution, because the author may not have an expectation of being able to sell the item. Additionally, when someone is searching a website for an item to buy, there may be many items that are similar to one another, which for example may be sold by competitors. The searcher may be bewildered by the many choices available, and may not have a manner of distinguishing the many choices from one another.

### SUMMARY

In an embodiment an item is offered for download at an initial offering, which may be free. In an embodiment, reviews of the item are sought. After receiving a predetermined number of orders for the item, increasing the price of the item. In an embodiment, the buyers establish accounts in a virtual bank and purchase the items with funds in the buyer's account in the virtual bank. In an embodiment items are presented to a potential buyer in an order dependent on the number of downloads of the items. Any of the above embodiments may be used alone or together with one another in any combination. Inventions encompassed within this specification may also include embodiments that are only partially mentioned or alluded to or are not mentioned or alluded to at all in this brief summary or in the abstract.

### BRIEF DESCRIPTION

In the following drawings like reference numbers are used to refer to like elements. Although the following figures depict various examples of the invention, the invention is not limited to the examples depicted in the figures.

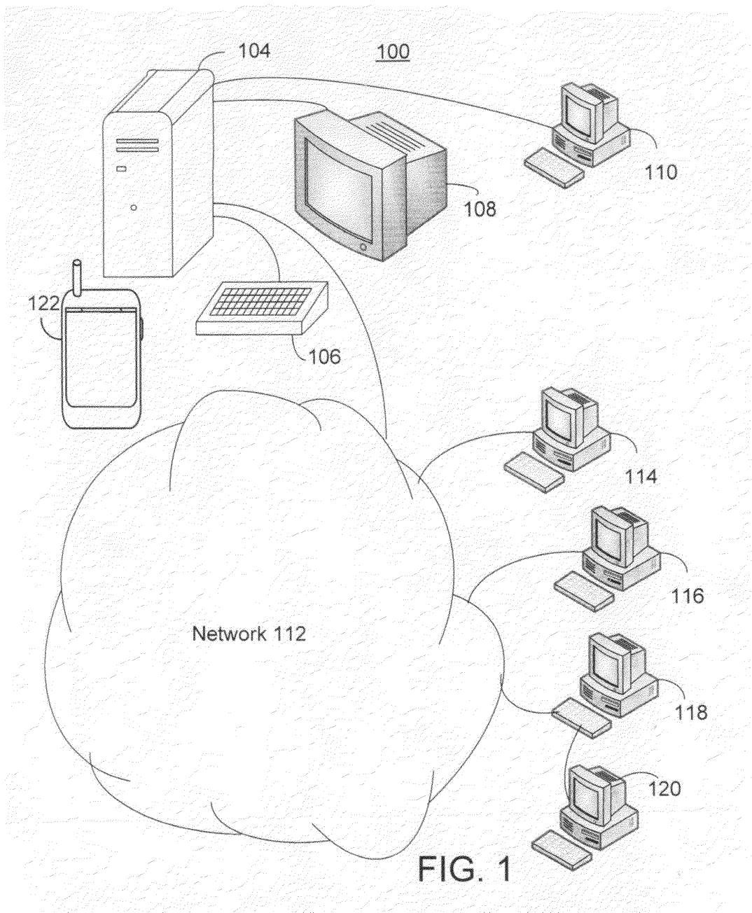

FIG. 1 shows an example of an embodiment of a system for online marketing.

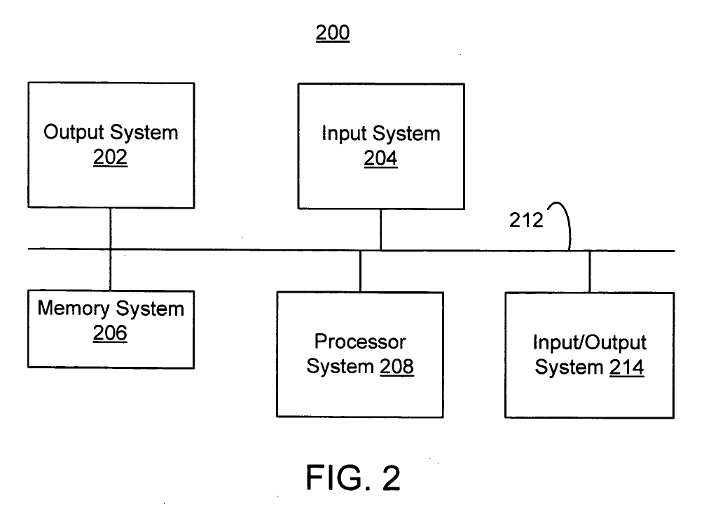

FIG. 2 shows a block diagram of an example of a system used in the system FIG. 1.

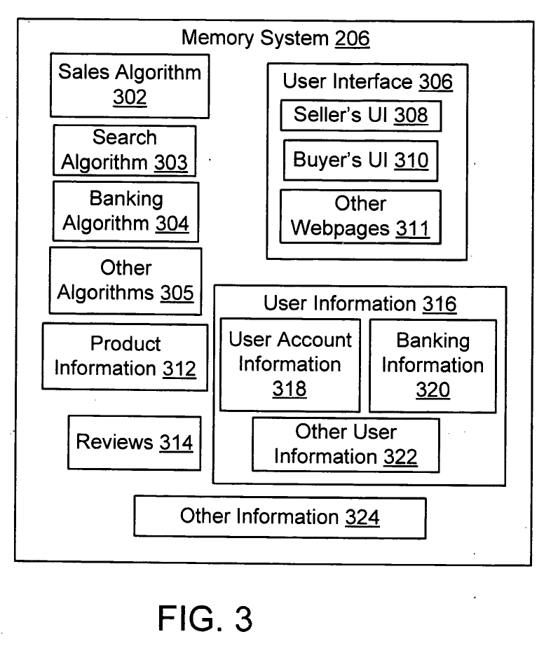

FIG. 3 shows a block diagram of an example of the contents of memory system of FIG. 2.

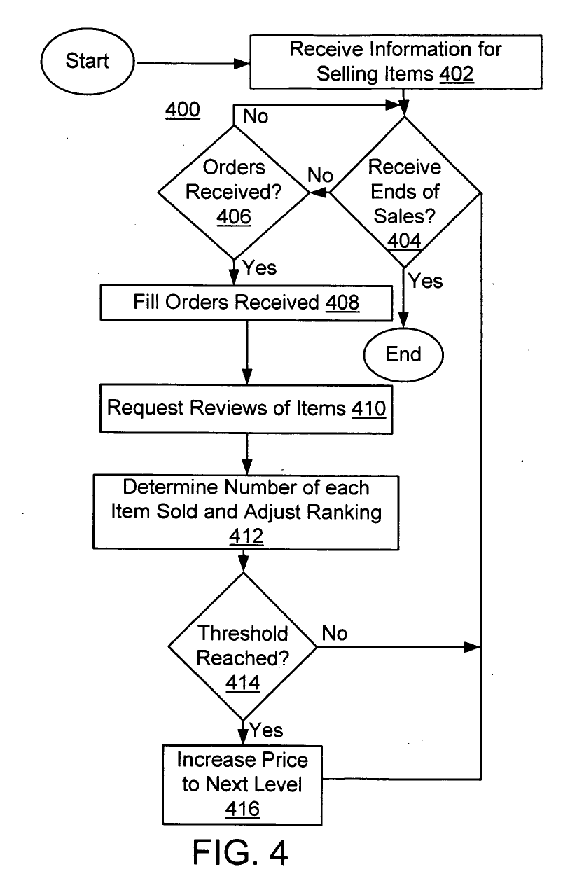

FIG. 4 shows a flowchart of an example of server-side method for selling items on the website associated with the server FIG. 1.

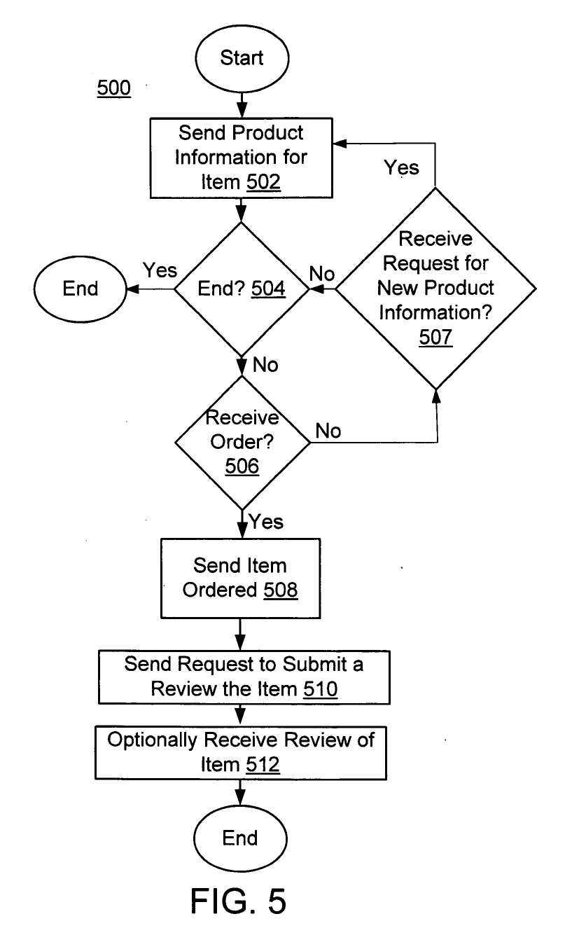

FIG. 5 shows a flowchart of an example of server-side method for selling items on the website associated with the server FIG. 1.

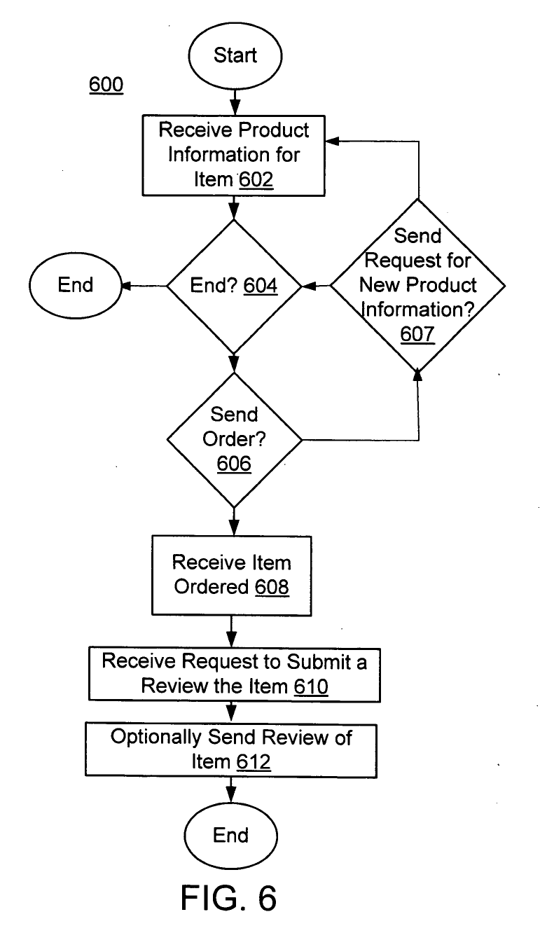

FIG. 6 shows a flowchart of an example of a client-side method for selling items on the website associated with the server FIG. 1.

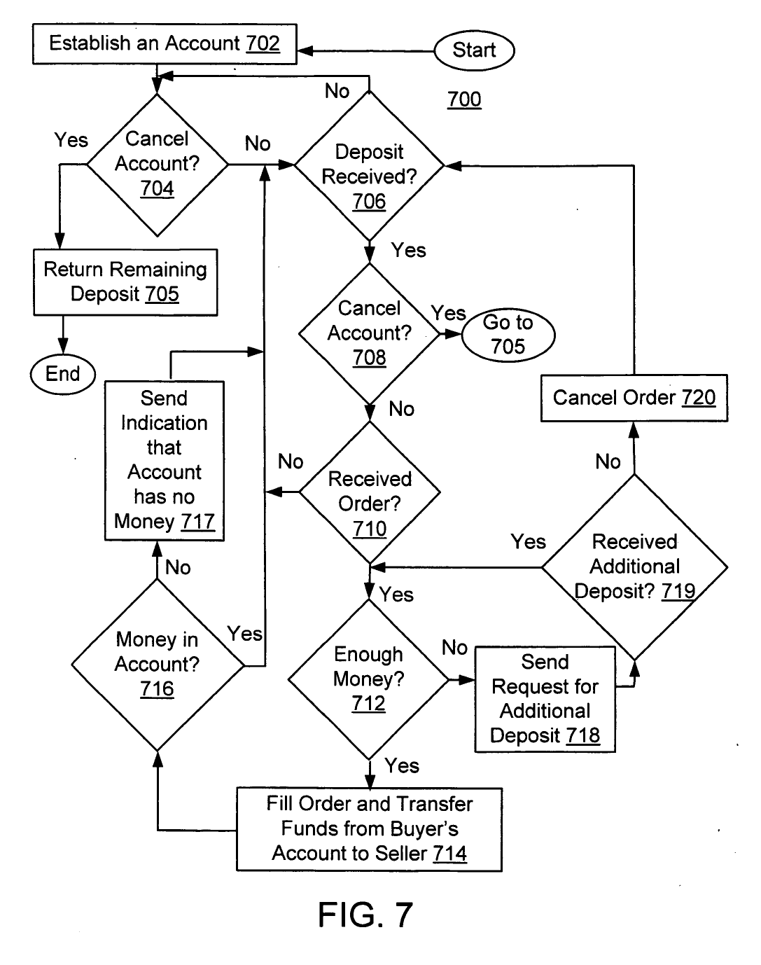

FIG. 7 shows a flowchart of an example of a server-side method for buying an item that is implemented by the server.

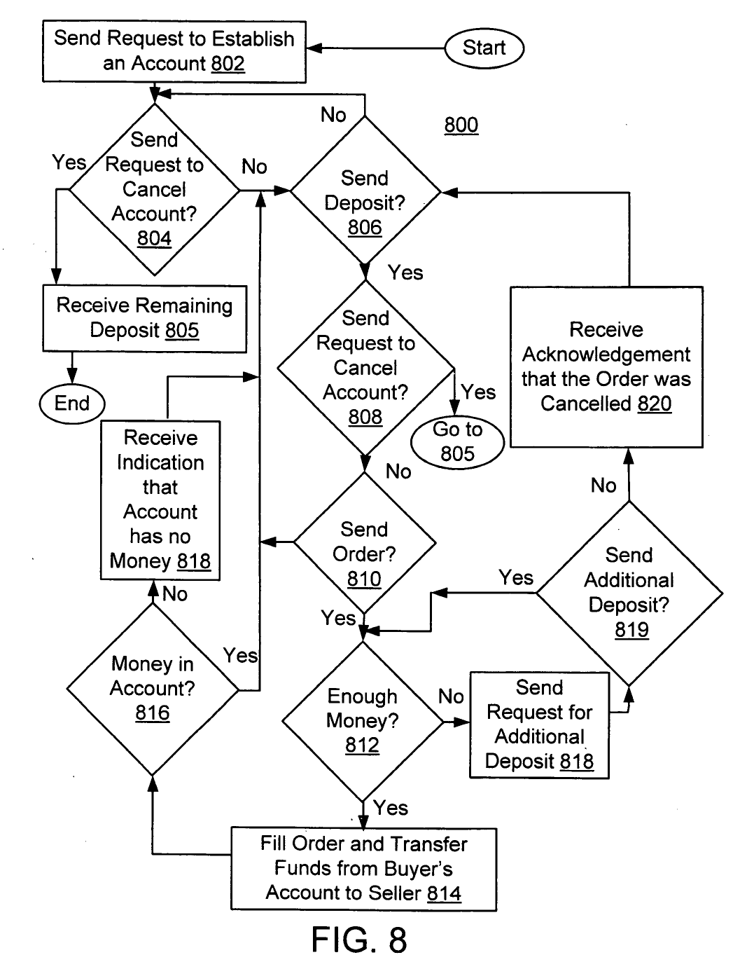

FIG. 8 shows a flowchart of an example of a method for buying an item that is implemented by the client.

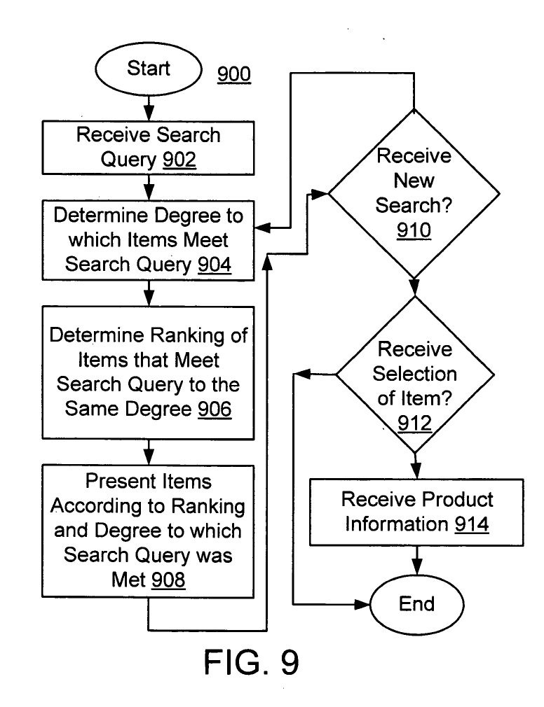

FIG. 9 shows a flowchart of an example of a method for searching for an item to download or purchase that is implemented by a server.

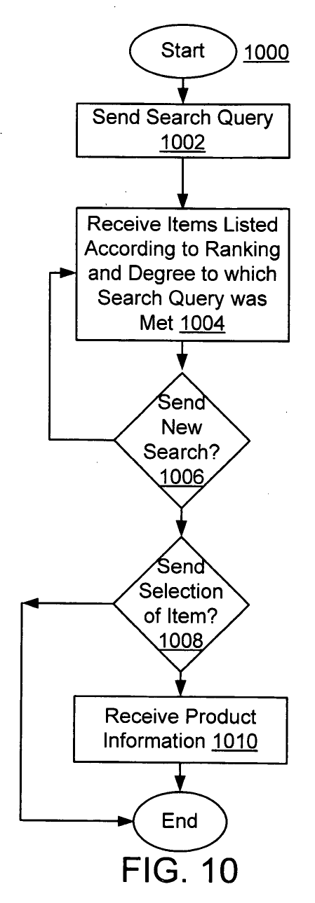

FIG. 10 shows a flowchart of an embodiment of a method for searching for an item to download or purchase that is implemented by the client.

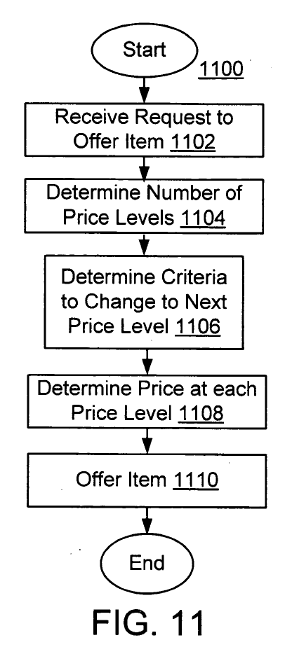

FIG. 11 shows a flowchart of an embodiment of a method of adding an item for sale or download implemented by the server.

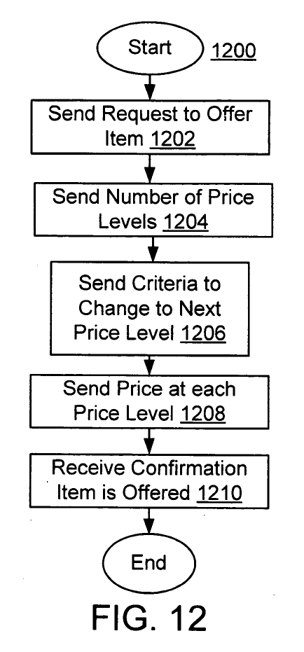

FIG. 12 shows a flowchart of an embodiment of a method adding an item for sale or download that is implemented by the client.

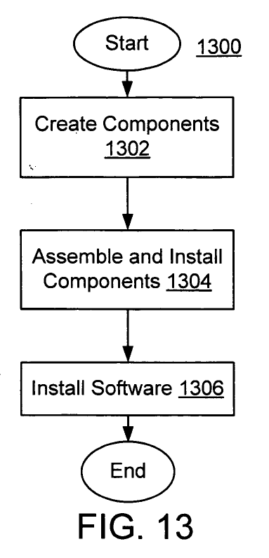

FIG. 13 shows a flowchart of an example of a method of assembling the system of FIG. 1.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

In general, at the beginning of the discussion of each of FIGS. 1-3 is a brief description of each element, which may have no more than the name of each of the elements in the one of FIGS. 1-3 that is being discussed. After the brief description of each element, each element is further discussed in numerical order. In general, each of FIGS. 1-13 is discussed in numerical order and the elements within FIGS. 1-13 are also usually discussed in numerical order to facilitate easily locating the discussion of a particular element. Nonetheless, there is no one location where all of the information of any element of FIGS. 1-13 is necessarily located. Unique information about any particular element or any other aspect of any of FIGS. 1-13 may be found in, or implied by, any part of the specification.

A website may be established in which one can post information for downloading and/or sale via the following method. The website may be used for selling ideas and/or other items.

### System

FIG. 1 shows an example of an embodiment of a system 100. System 100 includes server system 104 having input system 106 and output system 108. System 100 also includes system 110, network 112, system 114, system 116, system 118, system 120, and system 122. In other embodiments system 100 may not have all of the elements listed above or may have other components instead of and/or in addition to those listed above.

System 100 illustrates some of the variations of the manners of connecting to the server system. Server system 104 may include a webserver application as well as software for a website and online marketing software. Server system 104 is directly connected to system 110, and is connected, via network 112, to system 114, system 116, system 118, and system 120. System 120 is connected to system 104 via system 118. Network 112 may be any one of, or any combination of, one or more Local Area Networks (LANs), Wide Area Networks (WANs), wireless networks, telephones networks, and/or other networks. Systems 110, 114, 116, and 118 are any system that an end user may use to access server system 104. For example, systems 110, 114, 116, and 118 may be personal computers, workstations, laptop computers, game consoles, handheld network enabled audio/video player, and/or any other network appliance. System 120 is an example of a system that accesses system 104, via the combination of network 112 and another system, which in this example is system 118. System 122 is an example of a handheld network wireless device, such as a mobile phone or a handheld network enabled audio/music player, which may also be used for accessing network content.

### Server

FIG. 2 shows a block diagram of a system 200 used in system 100. System 200 may include output system 202, input system 204, memory system 206, processor system 208, communications system 212, and input/output device 214. In other embodiments system 200 may not have all of the elements listed above or may have other components instead of and/or in addition to those listed above.

System 200 is an example of a computer that may be used for any of systems 104, 110, 114, 116, 118, and/or 120, for example.

Output system 202 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Input system 204 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example.

Memory system 206 may include, for example, any one of, some of, any combination of, or all of a long term storage system, such as a hard drive; a short term storage system, such as random access memory; a removable storage system, such as a floppy drive or a removable drive; and/or flash memory. Memory system 206 may include one or more machine readable mediums that may store a variety of different types of information. The term machine-readable medium is used to refer to any medium capable carrying information that is readable by a machine. One example of a machine-readable medium is a computer-readable medium. Another example of a machine-readable medium is paper having holes that are detected that trigger different mechanical, electrical, and/or logic responses.

Processor system 208 may include any one of, some of, any combination of, or all of multiple parallel processors, a single processor, a system of processors having one or more central processors and/or one or more specialized processors dedicated to specific tasks.

Communications system 212 communicatively links output system 202, input system 204, memory system 206, processor system 208, and/or input/output system 214 to each other. Communications system 212 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 214 may include devices that have the dual function as input and output devices. For example, input/output system 214 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 214 is optional, and may be used in addition to or in place of output system 202 and/or input device 204.

### Application Implementing Online Marketing

FIG. 3 shows a block diagram of an example of the contents of memory system 206 in an embodiment in which computer system 200 (FIG. 1) is used for server system 104 (FIG. 1). Memory system 206 may store sales algorithm 302, search algorithm 303, banking algorithm 304, other algorithms 305, user interface 306, seller's UI 308, buyer's UI 310, other webpages 311, product information 312, reviews 314, user information 316, user account information 318, banking information 320, other user information 322, and other information 324. In other embodiments memory system 206 may not have all of the elements listed above or may have other components instead of and/or in addition to those listed above.

Sales algorithm 302 may initially, offer an item for free or for a low price, and reviews of the item may be solicited. After a fixed number of downloads or orders of the item, an initial price is set for the item, and the items are sold at the initial price. After a fixed number of more items is purchased, the price may be raised. The price may be raised again after another fixed number of items are purchased. Raising the price after a fixed number of sales of the item is continued until a predetermined maximum price is reached. People may be more willing to pay a higher price after others have purchased or obtained the item, thereby attesting to the value of the item. Also, people may be more willing to purchase an item after it has been reviewed by those that obtained the item at any price (e.g., even for free) and/or after the item has been reviewed by those that bought the item at a price that is not too much lower than the current price.

In an alternative embodiment, instead of initially offering the item for free, the item is initially offered for a relatively low price. Sales algorithm 302 may allow a seller to choose how many price levels to set. There may be zero price levels or any number of price levels between the initial offering and the maximum price. Sales algorithm 302 may establish multiple categories, and the number of price levels and the price at each price level may depend on the category. The number of orders for the item between price jumps may be the same for each price jump at each price level or may be different at different price jumps and/or price levels. In an embodiment, the user may be allowed to set the number of levels, the criteria to jump to the next level, such as the number of sales between each price level.

Other factors may be included in the pricing scheme, such as the velocity and/or acceleration of the sales. Some items may only be offered to a small number of purchasers for a relatively high price. Different types of items may have different monetary amounts between jumps in price. For example, some items may jump 5 cents at each benchmark of sales and others may increase $5. Different types of items may have different maximum prices. For example, there may be different categories of items, and each category may have a different maximum price, a different number of orders for the item at which the price jumps, and/or different prices to which the price jumps at each jump. In another embodiment, the user that is selling the item may be able to set the maximum price, the number of sales at which the price jumps, and/or the different price levels.

Search algorithm 303 may be used by end users to find items being offered. Search algorithm 303 return results in an order that depends on the number of items that were delivered. Search algorithm 303 may allow searching according to category. Search results from search algorithm 303 for a given item and/or within a given category may be ranked based at least partially on the number of orders that were received for a given item. Those items that have more orders would be ranked higher search by algorithm 303 and would also appear higher up on the list of search results (which may be referred to as a hit list or a results list) than similar items and/or items of the same category. The user may also be able to specify a price range and/or price level as one of the search parameters when entering a search into search algorithm 303.

Banking algorithm 304 may allow end users to establish deposit accounts in which money is deposited for later use in purchasing items. In order to allow for easy sale of items with low prices a virtual bank may be established, via banking algorithm 304 where the user provides a credit card and/or deposits an initial amount of money. Banking algorithm 304 may allow a user to buy monetary credits using a charge card, and the monetary credits may be used for purchasing items. The monetary credits may be labeled using monetary units and there may be one-to-one conversion ratio between the monetary units purchased and the money spent. For example, the monetary units of banking algorithm 304 may be labeled in dollars, and a one dollar charge from the end user's charge card may purchase one dollar in monetary credits. Optionally, banking algorithm 304 may charge a banking fee for depositing money into the end user's account, conducting transactions, and/or for other services. Banking algorithm 304 may include an algorithm for establishing a password. After an account is established, funds (e.g., in the form of monetary credits) are applied to purchases by just providing the password or some other secure form of approval. Since credit card information is not asked for with each purchase, the individual purchases require less effort, and the user is more likely to not mind purchasing multiple items of low value (e.g., for 5 cents each or even for less than a penny each).

Optionally, banking algorithm 304 allows purchases of items that cost less than the smallest denomination of monetary credit or of the end user's currency. For example, banking algorithm 304 may allow the user to charge an amount of less than one cent. Or even to offer a compensation for trying the item. Banking algorithm 304 may also establish accounts for the sellers of merchandise, which are credited every time a purchase is made of the seller's item. There may be a certain minimum amount of monetary credits that need to be collected prior to sending the seller a check for the items purchased. For example, the total credits credited to a seller's account may need to be greater than the smallest denomination of that the seller uses prior to receiving a check. For example, the total credits may need to be greater than a penny prior to issuing a check to the seller for items purchased. Alternatively, the total credits may need to be greater than another amount that is greater than the expense of issuing a check, prior to issuing a check. By simplifying the purchasing process and making purchases of items of small amounts of money more convenient, it becomes easier to sell ideas such as a single joke, which would not be expected to have a high market value. By demonstrating that other people liked what they ordered as evidenced by the number of orders, the velocity, and/or acceleration of the orders, people may be willing to purchase items on which they ordinarily would not consider spending money.

Other Algorithms 305 may include other algorithms that are used to run the website and related computations. User interface 306 may be a series of webpages that are served to visitors to the website. Seller's UI 308 may include the webpages served to an end user for selling items. Buyer's UI 308 may include the webpages served to an end user for buying an item. Buyer's UI 308 may include webpages for presenting product information and one or more fields for entering information for searching for an item or a type of item. Other webpages 310 may include other webpages that are not part of either buyer's UI 306 or seller's UI 308, such as webpages that provide general information about the website.

Product information 312 may include information about the items being offered to those that request (e.g., being offered for sale or being offered for free). For example, product information 312 may include a description of the item and the current price. In some cases, such as jokes, applications, recipes, books, music, pictures, and videos, the actual item may be stored in product information 312.

Reviews 314 include reviews of items being offered. Reviews 314 may include a text portion that allows the reviewer to write whatever the reviewer wants to write. Reviews 314 may include a numerical value or a score, such as a number of stars.

User information 316 include information collected about users. User account information 318 includes information necessary to start and/or maintain an account for buying or selling items. Banking information 320 includes information related to account balances and credit card information. Account balances include information about money deposited in the accounts by the end users for the purposes of purchasing items later. Account balances include balances that result from receiving sales revenue. Other user information 322 includes other information about the users. Other information 324 includes other information used for the website.

### Server Side Method of Selling Items

FIG. 4 is a flowchart of an example of method 400 is for selling items on the website associated with the server FIG. 1, which is implemented on the server side of network 112. Method 400 may be included within sales algorithm 304. In step 402, system 104 (FIG. 1) receives information for selling items. The information for selling an item may include information about the item, a marketing strategy (e.g., information about the number of price levels to offer, and the criteria to switch price levels), and/or other information about the items, which may be stored in product information 314 (FIG. 3). Also as part of step 402, the items are offered for free or for sale. Step 402 may include receiving information at different times for many different items from many different sellers. Although step 402 is indicated as being performed at a particular point in the flowchart of method 400, the receiving of information for a new item, associated with step 314, may be performed at any time during method 400.

In step 404, a determination is made whether any of the sellers chose to end a sale of an item. If a request to end a sale of an item is received, method terminates 400 for that item, but may continue to step 404 for all other items. If no request to end a sale is received, the method continues to step 406 for all items. In step 406, a determination is made whether an order for an item is received. For those items for which no orders for items were received, method 400 returns to step 404, to determine whether a sale for any item should end. If one or more orders for items are received, method 400 continues to step 408 where orders are filled. Step 408 may include sending confirmations of orders received, sending the actual item received, sending instructions to deliver the items. Step 408 may include sending a link that allows the buyer to download the item, receiving an indication that the link was selected, and then sending the item via network 112, for example. In step 410, requests for reviews of the items sold are sought. Step 410 may include presenting a link to the buyer that opens a page for entering comments, receiving an indication that the link was selected, sending a page for entering comments, receiving the comments entered, and saving the comments in association with the item in a manner that is readily accessible to other buyers. Step 410 may occur at anytime during method 400. In step 412, for each item sold, a tally of the number of those items sold is updated and stored. In step 414, for each item sold, a determination is made whether a criterion has been reached for increasing the price to the next price level. For example, the criteria may be whether a threshold number of a particular item has been sold, and a determination may be made whether a threshold number of a given item has been sold. If the criterion has been met, method 400 proceeds to step 416, where the prices are increased to the next price level for those items meeting their criteria for increasing the price. After step 416 or alternatively for those items that did not meet their criteria for increasing the price, method 400 proceeds to step 404.

In an embodiment, each of the steps of method 400 is a distinct step. In another embodiment, although depicted as distinct steps in FIG. 4, steps 402-416 may not be distinct steps. In other embodiments, method 400 may not have all of the above steps and/or may have other steps in addition to or instead of those listed above. The steps of method 400 may be performed in another order. Subsets of the steps listed above as part of method 400 may be used to form their own method.

FIG. 5 is a flowchart of an example of method 500 for selling (similar to method 400 of FIG. 4) items on the website associated with server 104 of FIG. 1, which is implemented on the server side of network 112. Method 500 may be included within sales algorithm 304. Method 500 differs from method 400 in that method 500 is a method that is implemented for an individual purchase, whereas method 400 is a method carried out by the server for handling multiple purchases. In step 502, a server system sends product information to the client. Step 502 may include sending information about the number of end-users that acquired the item, reviews of the item (if available), and/or the current price of the item. Optionally, the product information sent may include the number of the items that were acquired at each price level, and the price level at which a reviewer (that wrote a particular review) obtained the item at the time of writing the review. Step 502 may include sending a link that opens a page where the buyer may read reviews. The price and other product information sent in step 502 may have been determined as a result of method 400. Step 502 may have several sub-steps, such as first sending information about a group of products, receiving a selection of one of the products of the groups, and sending product information for the product selected.

In step 504, a determination is made whether an indication was received that the buyer wants to terminate method 500. For example, the server may receive an indication that a link was selected by the buyer to view another page rather than purchase the item being viewed. If, as a result of the determination of step 504, it is determined that the indication was received that the buyer wants to terminate the process, method 500 is terminated. After terminating method 500, method 500 may be restarted and in step 502 product information of a different product may be sent to the client. If, as a result of the determination of step 504, it is determined that an indication was not received that the buyer wants to terminate the process, method 500 continues to step 506. In step 506, a determination is made whether to send the order. If as a result of step 506 a determination is made not to send the order, method 500 proceeds to step 507. In step 507 a determination is made whether to request information about another product. If, in step 507, a determination is made not to request information about another product, method 500 proceeds to step 504 to determine whether to terminate the process. If in step 507, a determination is made to request information about another product, method 500 proceeds to step 502 for requesting product information about another product.

Returning to step 506, if a determination is made to send the order, method 500 proceeds to step 508. In step 508, the item ordered is sent or a method of obtaining the item ordered is sent. In step 510, the buyer receives an indication of how to submit a review of the product received. For example, step 510 may include receiving a link to a webpage where a review may be entered. In optional step 512, a review of the product is received. After optional step 512 or after step 510 (if step 512 is not present), method 500 terminates.

In an embodiment, each of the steps of method 500 is a distinct step. In another embodiment, although depicted as distinct steps in FIG. 5, steps 502-512 may not be distinct steps. In other embodiments, method 500 may not have all of the above steps and/or may have other steps in addition to or instead of those listed above. The steps of method 500 may be performed in another order. Subsets of the steps listed above as part of method 500 may be used to form their own method.

### Client Side Method of Buying Items

FIG. 6 is a flowchart of an example of method 600 for selling items on the website associated with the server FIG. 1, which is implemented on the client side of network 112. In step 602, a client system receives product information. Step 602 may include receiving information about the number of end-users that acquired the item, reviews of the item (if available), and/or the current price of the item. Optionally, the product information received may include the number of the items that were acquired, the number of the items that were acquired at each price level, and/or the price level at which a reviewer (whom wrote a particular review) obtained the item at the time of writing the review. Step 602 may include receiving a link that opens a page where the buyer may read reviews. The price and other product information viewed in step 602 may have been determined as a result of method 400. Step 602 may have several sub-steps, such as first receiving information about a group of products, sending a selection of one of the groups of products, and receiving product information for the product selected.

In step 604, a determination is made whether the buyer wants to terminate method 600. For example, the buyer may send an indication that a link was selected to view another page rather than purchase the item being viewed. If, as a result of the determination of step 604, it is determined that the buyer wants to terminate the process, method 600 is terminated. After terminating method 600, method 600 may be restarted and in step 602 product information of a different product may be received. If, as a result of the determination of step 604, it is determined that the buyer does not want to terminate the process, method 600 continues to step 606. In step 606, a determination is made whether to send the order. If as a result of step 606 a determination is made not to send the order, method 600 proceeds to step 607. In step 607 a determination is made whether to request information about another product. If in step 607, a determination is made not to request information about another product, method 600 proceeds to step 604 to determine whether to terminate the process. If in step 607, a determination is made to request information about another product, method 600 proceeds to step 602 for requesting product information about another product.

Returning to step 606, if a determination is made to send the order, method 600 proceeds to step 608. In step 608, the item ordered is received or a method of obtaining the item ordered is received. In step 610, the buyer receives an indication of how to submit a review of the product received. For example, step 610 may include receiving a link to a webpage where a review may be entered. In optional step 612, the buyer sends a review of the product. After optional step 612 or after step 610 (if step 612 is not present), method 600 terminates.

In an embodiment, each of the steps of method 600 is a distinct step. In another embodiment, although depicted as distinct steps in FIG. 6, steps 602-612 may not be distinct steps. In other embodiments, method 600 may not have all of the above steps and/or may have other steps in addition to or instead of those listed above. The steps of method 600 may be performed in another order. Subsets of the steps listed above as part of method 600 may be used to form their own method.

### Server Side Method of Buying an Item

FIG. 7 shows an example of a method 700 implemented by the server of buying an item. Method of 700 may be included within banking algorithm 304 and/or sales algorithm 303. In step 702, an account is established. Step 702 may involve receiving a request to establish an account and setting up the account. In step 704, a determination is made whether a request to cancel the account is received. If a request to cancel the account is received, method 700 proceeds to step 705. In step 705, the server cancels the account, and method 700 terminates. If in step 704 a determination is made that the no request to cancel the account was received, then method 700 continues to step 706. In step 706, a determination is made whether a deposit was received. If the deposit is not received, method 700 continues to step 704 to determine whether to cancel the account. If the deposit is received, method 700 continues to step 708 to determine whether a request to cancel the account was received. Step 708 is similar to step 704 in that in both a determination is made whether to cancel the account. In step 708, if a determination is made to that a request to cancel the account was received, then the process proceeds to step 705, where the account is canceled and if there is money in the account, the money is returned.

Returning to step 708, if no request to cancel the account is received, method 700 continues to step 710. In step 710, a determination is made whether an order was received. If an order was not received, method 700 proceeds to step 708 to check whether to cancel the account.

Returning to step 710, if an order was received, method 700 proceeds to step 712. In step 712 a determination is made whether there is enough money in the account for the order. If there is enough money in the account for the order, method 700 proceeds to step 714. In step 714, the order is filled. Step 714 may involve removing funds from the buyer's account and adding funds to the seller's account. After step 714, method 700 proceeds to step 716. In step 716, a determination is made whether there is still money in the account. If there is money in the account, method 700 proceeds to step 706, where as a result of steps 704, 706, 708, and 710, the buyer has the opportunity to cancel the account, deposit more money, and/or place another order. If there is no money in the account method 700 proceeds to step 717. In step 717, the buyer is given a notification that there is not money in the account. After step 717, method 700 continues to step 706.

Returning to step 712, if there is not enough money in the buyer's account, method 700 continues step 718. In step 718, a request is sent to the buyer to add money to the account for completing the order. After step 718, method 700 continues to step 719. In step 719, a determination is made whether more funds are received. If more funds are received, method 700 continues to step 712 to determine if there is enough money. Returning to step 719, if a determination is made that the more funds were not sent, method 700 continues to step 720, where the order is canceled. After step 720, method 700 continues to step 706. Then, as a result of step 704, 706, 708, and 710, the buyer has the option to add more money to the account, cancel the account, and/or place another order.

Although the flowchart for method 700 shows specific points for canceling an account, in an embodiment, an account may be cancelled at any time after the account is opened. Although the flowchart for method 700 shows specific points for canceling an order, in an embodiment an order may be canceled anytime after the order is received.

In an embodiment, each of the steps of method 700 is a distinct step. In another embodiment, although depicted as distinct steps in FIG. 7, steps 702-720 may not be distinct steps. In other embodiments, method 700 may not have all of the above steps and/or may have other steps in addition to or instead of those listed above. The steps of method 700 may be performed in another order. Subsets of the steps listed above as part of method 700 may be used to form their own method.

### Client Side Method of Buying an Item

FIG. 8 shows an example of a method 800 implemented by the server of buying an item. In step 802, a request to establish an account is sent to the server. In step 804, the buyer makes a determination whether to request to cancel the account. If (e.g., as part of step 804) the buyer requests to cancel the account, method 800 proceeds to step 805. In step 805, the buyer receives remaining funds in the account, and then method 800 terminates. If in step 804 the buyer decides not to request to cancel the account, then method 800 continues to step 806. In step 806, the buyer determines whether to send a deposit. If the buyer decides to not to send the deposit, method 800 continues to step 804 where the buyer decides whether to cancel the account. If as part of step 804 the buyer sends the deposit, method 800 continues to step 808, where the buyer decides whether to request to cancel the account. Step 808 is similar to step 804 in that in both the buyer decides whether to cancel the account. In step 808, if a determination is made to send a request to cancel the account, then the method 800 proceeds to step 805, where the buyer sends a request to cancel the account and if there is money in the account, the buyer receives the money.

Returning to step 808, if no request to cancel the account is sent, method 800 continues to step 810. In step 810, a determination is made whether to send an order to the server. If an order is sent, method 800 proceeds to step 808 where the buyer determines whether to send a request to cancel the account.

Returning to step 810, if an order was sent by the buyer to the server, method 800 proceeds to step 812. In step 812 a determination is made whether there is enough money in the account for the order. If there is enough money in the account for the order, method 800 proceeds to step 814. In step 814, the buyer receives the order. Step 814 may involve the buyer receiving an indication that funds were removed from the buyer's account and were sent to the seller's account. After step 814, method 800 proceeds to step 816. In step 816, a determination is made whether there is still money in the account. If there is money in the account, method 800 proceeds to step 806, where as a result of steps 804, 806, 808, and 810, the buyer decides whether to cancel the account, deposit more money, and/or place another order. If there is no money in the account method 800 proceeds to step 817. In step 817, the buyer receives a notification that there is not money in the account. After step 817, method 800 continues to step 806.

Returning to step 812, if there is not enough money in the buyer's account, method 800 continues step 818. In step 818, the buyer receives a request to add money to the account for completing the order. After step 818, method 800 continues to step 819. In step 819, the buyer decides whether to send more funds. If more funds are sent, method 800 continues to step 812 to determine if there is enough money. Returning to step 819, if a determination is made not to send funds, the funds are not sent and method 800 continues to step 820, where the buyer receives a confirmation that the order was cancelled. After step 820, method 800 continues to step 806. Then, as a result of step 804, 806, 808, and 810, the buyer has the option to add more money to the account, cancel the account, and/or place another order.

Although the flowchart for method 800 shows specific points for canceling an account, in an embodiment, an account may be cancelled at any time after the account is opened. Although the flowchart for method 800 shows specific points for canceling an order, in an embodiment an order may be canceled anytime after the order is received.

In an embodiment, each of the steps of method 800 is a distinct step. In another embodiment, although depicted as distinct steps in FIG. 8, steps 802-820 may not be distinct steps. In other embodiments, method 800 may not have all of the above steps and/or may have other steps in addition to or instead of those listed above. The steps of method 800 may be performed in another order. Subsets of the steps listed above as part of method 800 may be used to form their own method.

### Server Side Method of Searching for an Item

FIG. 9 shows a flowchart of a method 900 for implementing a sever side method of searching for an item to download or purchase. Method 900 may be included within search algorithm 303. In step 902, a search query is received from the buyer to the server. In step 904, the server determines the degree to which various items meet the search query. In step 906, a ranking is determined for the items found. In an embodiment, the ranking is based on the number of items purchased. For example, items that have the same relevance to the search may be ranked according to the number of items sold. In step 908, the search results are sent to the user, for presentation in an order based on the ranking and the relevance to the search. In step 910, a determination is made whether a new search query was received. If a new search query was received, method 900 continues to step 904 to determine the relevance of items to the search query. If in step 910 a new search is not received, a determination is made whether a selection of one of the items was received. If it is determined that no item was selected, method 900 terminates. If in step 910, it is determined that an item was selected, method 900 proceeds to step 912. In step 912, more information is sent to the buyer about the item selected. The product information sent may include a link to start a purchasing process for purchasing the item selected. After step 912, method 900 terminates. After method 900 terminates, step 710 of method 700 may be performed.

In an embodiment, each of the steps of method 900 is a distinct step. In another embodiment, although depicted as distinct steps in FIG. 9, steps 902-912 may not be distinct steps. In other embodiments, method 900 may not have all of the above steps and/or may have other steps in addition to or instead of those listed above. The steps of method 900 may be performed in another order. Subsets of the steps listed above as part of method 900 may be used to form their own method.

### Client Side Method of Searching for an Item

FIG. 10 shows a flowchart of a method 1000 for implementing a client side method of searching for an item to download or purchase. In step 1002, a search query is sent from the buyer to the server. In step 1004, search results are received that have the items listed in an order based on ranking and relevance to the search. In step 1006, the buyer decides whether to send a new search. If the buyer decides to send a new search, method 1000 proceeds to step 1002. If the buyer decides not to send a new search, the user decides whether to send a selection of one of the items returned with the search results. If the buyer decides not to send a selection, method 1000 terminates. If the buyer decides to send a selection, method 1000 proceeds to step 1008. In step 1008, the buyer receives product information about the item selected. The product information sent may include a link to start a purchasing process for purchasing the item selected. After step 1008, method 1000 terminates. After terminating, the buyer may decide to implement step 810 of method 800 (FIG. 8).

In an embodiment, each of the steps of method 1000 is a distinct step. In another embodiment, although depicted as distinct steps in FIG. 10, steps 1002-1008 may not be distinct steps. In other embodiments, method 1000 may not have all of the above steps and/or may have other steps in addition to or instead of those listed above. The steps of method 1000 may be performed in another order. Subsets of the steps listed above as part of method 1000 may be used to form their own method.

### Server Side Method of Adding an Item for Sale

FIG. 11 shows a flowchart of an embodiment of a method 1100 implementing a server side method of adding an item for sale or download. In step 1102, a request is received for offer an item for sale. In step 1104, the number of price levels are determined. The determination may be the result of requesting from the user how many price levels to include. Additionally or alternatively, the number of price levels may be determined based on characteristics of the item, such as the category of the item and/or the size or volume of the item (e.g., the number of jokes sold together as a booklet). In step 1106, one or more criteria are determined for when a price jump should occur. The one or more criteria may be based on characteristics of the item, such as a category to which the item belongs. For example, a single joke may jump in price after more downloads than a single recipe. Also a book of jokes may increase in price after fewer downloads than a single joke. The one or more criteria may also include one or more criteria selected by the user. For example, the user may be sent an option to select the number of downloads of the item that triggers an increase in price of the item. In step 1108, the price for each level is determined, which may be the result of requesting from the user how many prices for each price level. Additionally or alternatively, the prices of each price level may be determined based on characteristics of the item, such as the category of the item and/or the size or volume of the item (e.g., the number of jokes sold together as a booklet). In step 1100, item is added to the other items that are being offered for download and/or sale.

In an embodiment, each of the steps of method 14100 is a distinct step. In another embodiment, although depicted as distinct steps in FIG. 11, steps 1102-1110 may not be distinct steps. In other embodiments, method 1100 may not have all of the above steps and/or may have other steps in addition to or instead of those listed above. The steps of method 1100 may be performed in another order. Subsets of the steps listed above as part of method 1100 may be used to form their own method.

### Client Side Method of Adding an Item for Sale

FIG. 12 shows a flowchart of an embodiment of a method 1200 implementing a client side method of adding an item for sale or download. In step 1202, a request is sent to offer an item for sale. In optional step 1204, the number of price levels for the item are sent to the server. The sending of the number of price levels may be in response to receiving a request to send the number of price levels. Alternatively or in addition to performing step 1204, the number of price levels may be determined automatically based on characteristics of the item. In step 1206, the seller may send one or more criteria for when a price jump should occur. Alternatively or in addition to performing step 1206, one or more criteria for determining when the price should jump based on categories may be determined based on characteristics of the item. In step 1208, the seller sends to the server the price for each level. Alternatively or in addition to performing step 1208, the prices of each price level may be determined based on the characteristics of the item. In step 1210, the buyer receives a confirmation that the item is being offered for download and/or sale.

In an embodiment, each of the steps of method 1200 is a distinct step. In another embodiment, although depicted as distinct steps in FIG. 12, steps 1202-1210 may not be distinct steps. In other embodiments, method 1200 may not have all of the above steps and/or may have other steps in addition to or instead of those listed above. The steps of method 1200 may be performed in another order. Subsets of the steps listed above as part of method 1200 may be used to form their own method.

### Method of Assembly

FIG. 13 shows a flowchart of an example of a method of assembling the system of FIG. 1. In step 1302, the components of system 100 are manufactured. For example, step 1302 may include manufacturing or otherwise creating the components of server system 104, system 110, network 112, system 114, system 116, system 118, system 120, and system 122. Creating the components of sever system 104, system 114, system 118, system 120, and/or system 122 may each include creating a corresponding set of output system 202, input system 204, memory system 206, processor system 208, communications system 212, and input/output device 214.

In step 1304 components of system 100 are assembled. For example as part of step 1304, server system 104, system 110, network 112, system 114, system 116, system 118, system 120, and system 122 may be communicatively coupled to one another. Also assembling sever system 104, system 114, system 118, system 120, and/or system 122 may each include communicatively coupling a corresponding set of output system 202, input system 204, memory system 206, processor system 208, communications system 212, and input/output device 214 to one another.

In step 1306, the software is installed. For example, step 1306 may include installing onto memory system 206 sales algorithm 302, search algorithm 303, banking algorithm 304, other algorithms 305, user interface 306, which may include installing seller's UI 308, buyer's UI 310, and other webpages 311. Step 1306 may also include setting aside portions of memory 1306 for product information 312, reviews 314, user information 316, user account information 318, banking information 320, other user information 322, and other information 324.

In an embodiment, each of the steps of method 1300 is a distinct step. In another embodiment, although depicted as distinct steps in FIG. 13, step 1302-1306 may not be distinct steps. In other embodiments, method 1300 may not have all of the above steps and/or may have other steps in addition to or instead of those listed above. The steps of method 1300 may be performed in another order. Subsets of the steps listed above as part of method 1300 may be used to form their own method.

In an embodiment, each of the steps of method 1300 is a distinct step. In another embodiment, although depicted as distinct steps in FIG. 13, steps 1302-1306 may not be distinct steps. In other embodiments, method 1300 may not have all of the above steps and/or may have other steps in addition to or instead of those listed above. The steps of method 1300 may be performed in another order. Subsets of the steps listed above as part of method 1300 may be used to form their own method.

### FURTHER DISCUSSION

Although the flowcharts of various methods show steps at which the method may be terminated, in at least one embodiment of each of the methods, the method may be terminated at any point. By giving people an opportunity to sell their ideas, more people may be encouraged to attempt to sell ideas that they otherwise would not publicize, which may benefit the public. Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method comprising:
offering an item at an initial offering;
determining when a set number of the items has been ordered; and
after determining that the set number was ordered, offering the item for a price that is higher than the initial offering.

2. The method of claim 1, the initial offering includes offering the item for free.

3. The method of claim 1, the item is an idea.

4. The method of claim 1, further comprising:
receiving a request to purchase the item, and
removing funds for the purchase from a pre-established account, the pre-established account having a positive balance prior to the removing of the funds.

5. The method of claim 4, the account being associated with a website, and the offering being associated with the website associated with the account.

6. The method of claim 1, further comprising:
receiving an order for the item,
in response to the order, sending the item to a location based on information associated with the order, and
sending a link for entering a review of the item ordered.

7. The method of claim 1, further comprising:
receiving a query for locating an item, the query including one or more characteristics of the item,
in response, determining a plurality of items to have the one or more characteristics included in the query, and
returning a listing of the plurality of items in an order associated with how many of each of the plurality of items were ordered.

8. The method of claim 1, further comprising:
receiving a request to establish an account, and
requesting an initial deposit to the account.

9. The method of claim 1, further comprising:
inviting potential sellers to offer items of small value for download.

10. The method of claim 1, the initial offering includes offering the item for free, the item is an idea, the method further comprising:
receiving a request to purchase the item;
removing funds for the purchase from a pre-established account, the pre-established account having a positive balance prior to the removing of the funds, the account being associated with a website, and the offering being associated with the website associated with the account;
receiving an order for the item;
in response to the order, sending the item to a location based on information associated with the order;
sending a link for entering a review of the item ordered;
receiving a query for locating an item, the query including one or more characteristics of the item;
in response, determining a plurality of items to have the one or more characteristics included in the query;
returning a listing of the plurality of items in an order associated with how many of each of the plurality of items were ordered;
receiving a request to establish an account;
requesting an initial deposit to the account; and
inviting potential sellers to offer items of small value for download.

11. A system comprising a machine readable medium storing thereon a method comprising:
offering an item at an initial offering;
determining whether a set number of the items has been ordered; and
after determining that the set number was ordered, offering the item for a price that is higher than the initial offering.

12. The system of claim 11, the machine-readable medium storing information about the item.

13. The system of claim 11, the initial offering includes offering the item for free.

14. The system of claim 11, the item is an idea.

15. The system of claim 11, the method further comprising:
receiving a request to purchase the item, and
removing funds for the purchase from a pre-established account, the pre-established account having a positive balance prior to the removing of the funds.

16. The system of claim 15, the account being associated with a website, and the offering being associated with the website associated with the account.

17. The system of claim 11, the method further comprising:
receiving an order for the item,
in response to the order, sending the item to a location based on information associated with the order, and
sending a link for entering a review of the item ordered.

18. The system of claim 11, the method further comprising:
receiving a query for locating an item, the query including one or more characteristics of the item,
in response, determining a plurality of items to have the one or more characteristics included in the query, and
returning a listing of the plurality of items in an order associated with how many of each of the plurality of items were ordered.

19. The system of claim 11, the computer readable medium storing thereon account information, the account information including at least
an account owner, and
how much money is in each account,
the method further comprising:
receiving a request to establish an account, and
requesting an initial deposit to the account.

20. The system of claim 11, the machine readable medium storing thereon one or more messages related to selling items of small value, the method further comprising: inviting potential sellers to offer items of small value for download.

21. The system of claim 11, the method comprising a machine-readable medium that stores thereon information about one or more items being offered for download,
the method further comprising:
receiving a request to establish an account, the account being associated with a website, and the offering being associated with the website associated with the account;
requesting an initial deposit to the account;
receiving a query for locating an item, the query including one or more characteristics of the item;
in response, determining a plurality of items to have the one or more characteristics included in the query;
returning a listing of the plurality of items in an order associated with how many of each of the plurality of items were ordered;
receiving a request to purchase the item;
removing funds for the purchase from the account established, the account having a positive balance prior to the removing of the funds;
receiving an order for the item;
in response to the order, sending the item to a location based on information associated with the order;
sending a link for entering a review of the item ordered; and
inviting potential sellers to offer items of small value for download; offering an item at an initial offering;
after offering the item for the higher price, determining when another set number of the items has been ordered; and
after determining that the set number was ordered, offering the item for a price that is higher than the higher price.

22. The system of claim 11, the item being one of a plurality of items, the computer readable medium storing thereon a plurality of categories into which the plurality of items are classified, each category being associated with predetermined price levels and each price level being associated with one or more predetermined criteria at which an offering for items categorized in the category changes to a higher price level.

23. The system of claim 22, the predetermined price levels including a maximum price level.

24. The system of claim 11, the item being one of a plurality of items, the computer readable medium storing thereon the plurality of items, each of the plurality of items being associated with predetermined price levels and each price level being associated with one or more predetermined criteria at which an offering for the item changes to a higher price level.
